(19) United States
(12) Patent Application Publication
(10) Pub. No.: US 2014/0279024 A1
(43) Pub. Date: Sep. 18, 2014

(54) SYSTEM FOR AND METHOD FOR A CONSUMER EXPERIENCE PLATFORM

(71) Applicant: CELLCO PARTNERSHIP D/B/A VERIZON WIRELESS, Basking Ridge, NJ (US)

(72) Inventors: Brigitte Bastaldo-Tsampalis, Bridgewater, NJ (US); Mohammad Ashfaq Kamal, King of Prussia, PA (US); Yuk Lun Li, Morganville, NJ (US); Asif Nooruddin Batada, Marietta, GA (US); Ioannis Tsampalis, Bridgewater, NJ (US); Manuel Enrique Caceres, Basking Ridge, NJ (US); Praveen Venkataramu, Bridgewater, NJ (US)

(73) Assignee: CELLCO PARTNERSHIP D/B/A VERIZON WIRELESS, Basking Ridge, NJ (US)

(21) Appl. No.: 13/826,160

(22) Filed: Mar. 14, 2013

(51) Int. Cl. G06Q 30/02

(52) U.S. Cl. CPC G06Q 30/0267; G06Q 30/0275
USPC 705/14.64

(57) ABSTRACT

Exemplary embodiments provide a campaign tool that enables content providers to bid for the opportunity to transmit their content mobile devices associated with consumers though a cloud based computing environment. The campaign tool is hosted by another entity. The content may be any of a variety of different contents types and may be tailored to be relevant to the consumer. The campaign tool may have a bidding system that implements one or more algorithms to manage the bidding process. The content is pushed to the mobile device following an affirmative action, such as an NFC tap, by the consumer.

### BACKGROUND INFORMATION

Mobile devices are used by many consumers. The consumers use these mobile devices for a variety of uses. These mobile devices have a variety of capabilities and features, including Near Field Communications (NFC) capability.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 depicts a system for content delivery to mobile devices according to exemplary embodiments.

FIG. 2 depicts a method for bidding on content delivery to mobile devices according to exemplary embodiments.

FIG. 3 depicts a method of delivery content to mobile devices according to exemplary embodiments.

FIG. 4 depicts the operation of a system for content delivery to mobile devices according to exemplary embodiments.

### DETAILED DESCRIPTION OF PREFERRED EMBODIMENTS

According to some embodiments, system and methods may provide a content delivery system or consumer experience platform that may deliver meaningful content to consumers through their mobile devices. A campaign tool may be hosted in a cloud-based computing environment. In some embodiments, the campaign tool may be hosted in other types of computing environments apart from a cloud-based environment. A combination of hosting environments may be used. The campaign tool may enable entities or content providers to bid for the opportunity for the campaign tool host to transmit their content to consumers though the cloud-based computing environment. For example, the content providers may include brands, retailers, marketing firms, service providers, and other such entities. The campaign tool may hosted by another entity or host. For example, a telecommunications provider may host the campaign tool. Other types of entities may host the campaign tool. The content may be any of a variety of different contents types. For example, the content may include offers, coupons, rewards, loyalty program information, advertisements, media, product information, articles, news, and other electronic content. The campaign tool may have a bidding system that implements one or more algorithms to manage the bidding process. The cloud-based computing environment may host more than one campaign tool.

The content providers bidding on delivering their content may specify particular parameters of the content, such as, but not limited to, when and where the content is delivered and the target set of consumers. The content providers bidding may be prescreened and/or approved prior to being able to participate in the bidding process.

The content may be pushed to consumers following a predetermined action by a consumer at a specified location. For example, the consumer may tap their mobile device at a Near-Field Communications (“NFC”) enabled location such as an NFC tag. The NFC tag may be tied to the cloud-based computing environment. The NFC tag may be located at any of a variety of locations. For example, the NFC tag may be located at retail locations, such as at point of sale (POS) locations (e.g., stores or POS terminals within the stores) or at common areas in shopping locations. The NFC tag may be specifically associated with exemplary embodiments. The NFC tag may be configured to be used with exemplary embodiments. Thus, the NFC tag, when tapped or otherwise actuated may provide functionality described herein according to exemplary embodiments. The NFC tag may be located in hotspots or in posters or other media. Following the tap, content may be pushed to the consumer's mobile device. The content may be pushed over a wireless network to the mobile device. For example, a cellular network or a wireless network may be used to push the content.

The mobile device may be any type of mobile computing device. For example, the mobile device may be a smart phone or a tablet computing device or other portable computing device. The mobile device may have an application to receive and manage the received content. In some embodiments, the mobile device may have a program installed by the hosting entity to receive and manage the content. The content pushed may be customized or tailored to the consumer based on a profile. The profile may be associated with the consumer and may contain preferences and a history of the consumer's actions including the use of exemplary embodiments. For example, the profile may contain information regarding the consumer's past NFC taps, pushed content, and redemption of offers. Thus the content pushed to the consumer's mobile device may be meaningful and relevant to the particular consumer. In some embodiments, a consumer may have multiple mobile devices. The content pushed to one mobile device may be pushed to the other mobile devices associated with the consumer. The consumer may register their mobile devices to allow this synchronization. In other embodiments, even if multiple mobile devices are associated with the consumer, content may be pushed to only a subset of the associated mobile devices based on, for example user preferences indicating the types of content to be sent to particular associated mobile devices.

The consumer may be able to register to have content pushed to their mobile device. The registration may be accomplished using a computer-based network. For example, a website may be used for registration of each associated mobile device. The consumer may be able to register through an application according to exemplary embodiments.

It should be appreciated that although exemplary embodiments describe the use of NFC, other methods and systems may be used to activate the content delivery. For example, Bluetooth or QR codes may be used. A combination of systems may be used. It should also be appreciated that the consumer may request a manual delivery of the content. For example, the customer may submit a request that particular content be pushed to a mobile device. This request may be done in a manner other than using an NFC tap, for example. The customer may submit such a request through an application or through a website.

Exemplary embodiments may provide feedback to the content providers. The host entity may provide a periodic report summarizing the content pushed to mobile devices. This periodic report may protect the privacy of the consumers by omitting specific consumer identifying information but include demographic or other data that does not identify specific consumers.

In the following figures, while a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized.

The description below describes network elements, computers, and components of exemplary embodiments. The elements depicted may be modules of a single larger element. Each of these elements may also include one or more modules. As used herein, the term “module” may be understood to refer to computer implemented executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

Exemplary embodiments may include software that is installed on computer hardware to allow the execution of instructions to implement the methods described herein. The software may be tangibly embodied in one or more non-transitory physical media, such as, but not limited to, a compact disc (“CD”), a digital versatile disc (“DVD”), a floppy disk, a hard drive, read only memory (“ROM”), random access memory (“RAM”), as well as other physical media capable of storing software, or combinations thereof.

Moreover, the figures illustrate various components (e.g., servers, computers, etc.) separately. The functions described as being performed at various components may be performed at other components, and the various components may be combined or separated. Other modifications also may be made.

FIG. 1 is a system according to an exemplary embodiment. The system 100 may include one or more terminals 102A, B, and C, a firewall 104, a provisioning platform 106, a bidding platform 108, a web server 110, a gateway 112, a network 114, a consumer 116, one or more mobile devices 118A, B, and C, computer 120, and one or more enterprise service buses (“ESB”) 122A, B, and C. The system 100 may represent a cloud-based computing environment for hosting a campaign tool according to exemplary embodiments. It should be appreciated that other types of computing environments may be used to host exemplary embodiments. For example, a grid, a client-server, or a distributed computing type environment may be used. A combination of computing environments may be used.

The terminals 102A, B, and C may be computing platforms. The terminals 102A, B, and C may be access points for content providers to access the system 100. The terminals 102A, B, and C may each be associated with a different entity that provides content. Thus, each of the terminals 102A, B, and C may be geographically separated. The terminals 102A, B, and C may each be communicatively coupled to a computer-based network. It should be appreciated that while three terminals are depicted, there may be more or less terminals in the system 100.

The computer-based network that each terminal 102A, B, and C is communicatively coupled to may be one or more of a wireless network, a wired network or any combination of wireless network and wired network. For example, the network may include one or more of a fiber optics network, a passive optical network, a cable network, an Internet network, a satellite network (e.g., operating in Band C, Band Ku or Band Ka), a wireless LAN, a Global System for Mobile Communication (“GSM”), a LTE-based network, a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the network may include, without limitation, telephone line, fiber optics, IEEE Ethernet 802.3, a Wide Area Network (“WAN”), a Local Area Network (“LAN”), or a global network such as the Internet. Also, the network may support, an Internet network, a wireless communication network, a cellular network, or the like, or any combination thereof. The network may further include one, or any number of the exemplary types of networks mentioned above operating as a stand-alone network or in cooperation with each other. The network may utilize one or more protocols of one or more network elements to which it is communicatively coupled. The network may translate to or from other protocols to one or more protocols of network devices. Although the network depicted in FIG. 1 between the terminals 102A, B, and C is each depicted as a single network between the terminal and the firewall 104, it should be appreciated that according to one or more embodiments, the network may be a plurality of interconnected networks, such as, for example, a service provider network, the Internet, a broadcaster's network, a cable television network, a corporate network, and a home network.

A firewall 104 may be positioned between the terminals 102A, B, and C and the provisioning platform 106. The provisioning platform 106 may be a computing device. The provisioning platform 106 may perform a variety of functions. For example, the provisioning platform 106 may enforce bidding policies, define access rights, serve as the upload point for content, and provision the content for mobile device distribution.

The bidding platform 108 may be a computing device. The bidding platform 108 may perform a variety of functions. For example, the bidding platform 108 may have open API's or Application Programming Interfaces for content providers, store content provider profile information, enforce bidding polices, and filter content. According to exemplary embodiments, the bidding platform 108 may be the first contact point a content provider has with the system 100. The bidding platform 108 may support submission of proposals for content delivery from content providers and may provide approval of such proposals prior to allowing a content provider access to other portions of the system 100, such as the provisioning platform 106.

The web server 110 may be a computing device. The web server 110 may perform a variety of functions. For example, the web server 110 may provide content to consumer mobile devices and adapt content to those mobile devices.

The gateway 112 may serve as the interface point between the web server 110 and the mobile devices 118A, B, and C and ultimately the consumer 116. The gateway 112 may provide a common layer across device types and process requests from the mobile device to the web server 110.

The network 114 may provide communicative coupling between each of the mobile devices 118A, B, and C and the web server 110. The network 114 may provide two way connectivity for the passage of both data and voice messages.

The network 114 may include a variety of network types including both wireless networks and wired networks. The network 114 may have multiple access points. For example, the network 114 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a LTE-based network, a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the network may include, without limitation, telephone line, fiber optics, IEEE Ethernet 802.3, a Wide Area Network (“WAN”), a Local Area Network (“LAN”), or a global network such as the Internet. Also, the network may support, an Internet network, a wireless communication network, a cellular network, or the like, or any combination thereof. The network may further include one, or any number of the exemplary types of networks mentioned above operating as a stand-alone network or in cooperation with each other. The network may utilize one or more protocols of one or more network elements to which it is communicatively coupled. The network may translate to or from other protocols to one or more protocols of network devices. Although the network 114 depicted in FIG. 1 is depicted as a single network, it should be appreciated that according to one or more embodiments, the network may be a plurality of interconnected networks, such as, for example, a service provider network, the Internet, a broadcaster's network, a cable television network, a corporate network, and a home network.

The computer 120 may be a computing device. The computer 120 may be communicatively coupled a computer-based network such as the network 114. The computing device 120 may be associated with a consumer. The computing device 120 may provide consumer access to the system 100.

As depicted in FIG. 1, various components of the system 100 may be communicatively coupled using one or more enterprise serial buses 122A, B, and C. Although three such buses are depicted, there may be more or less according to exemplary embodiments. The enterprise serial buses or ESBs may allow for communicative coupling between the various components of the system 100.

In the networks of FIG. 1, such as those communicatively coupling the terminals 102A, B, and C to the firewall 104, the enterprise serial buses 122A, B, and C, and the network 114, data may be transmitted and received utilizing a standard telecommunications protocol or a standard networking protocol. For example, data may be transmitted and received using Wireless Application Protocol (“WAP”), Multimedia Messaging Service (“MMS”), Enhanced Messaging Service (“EMS”), Short Message Service (“SMS”), Global System for Mobile Communications (“GSM”)-based systems, LTE-based systems, Code Division Multiple Access (“CDMA”)-based systems, Transmission Control Protocol/Internet (“TCP/IP”) Protocols, or other protocols and systems suitable for transmitting and receiving broadcast data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. For example, the network 114 may use standard wireless protocols such as, for example, IEEE 802.11a, 802.11b 802.11g, and 802.11n. The network 114 may also use protocols for a wired connection, such as IEEE Ethernet 802.3.

Each of the computing devices depicted in the system 100 may include one or more processors for recording, transmitting, receiving, and storing data. Each of the computing devices in the system 100 may be a servers (or server-like device). Each of the computing devices may have a form of data storage associated therewith. The data storage may be network accessible storage and may be local, remote, or a combination thereof. The data storage may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, the data storage may be a database, such as an Oracle database, a Microsoft SQL Server database, a DB2 database, a MySQL database, a Sybase database, an object oriented database, a hierarchical database, or other database. The data storage may utilize flat file structures for storage of data.

FIG. 2 is a method according to exemplary embodiments. Exemplary method 200 is provided by way of example, as there are a variety of ways to carry out the methods disclosed herein. The method 200 as shown in FIG. 2 may be executed or otherwise performed by one or a combination of various systems, such as a computer implemented system. For example, the system 100 may be used to implement the method 200. Each block shown in FIG. 2 represents one or more processes, methods, and/or subroutines carried out in the exemplary method 200. Each block may have an associated processing machine or the blocks depicted may be carried out through one processor machine.

At block 202, an entity accesses a content delivery system. The entity may be a content provider. The entity may access the content delivery system through a terminal, such as a computing device. The access may be to a bidding platform as described above in the system 100. The terminal may be remotely located and communicatively coupled to a computer-based network. The entity may access the content delivery system through the computer-based network using one or more interfaces. For example, the interfaces may be web based interfaces, such as a web page. In some embodiments, the terminal may be a dedicated terminal for the content delivery system.

At block 204, a proposal for content delivery is submitted by the entity through the terminal to the content delivery system. The proposal may include information regarding the content provider and what type of content the content provider provides. The proposal may include a profile of the content provider. The profile may include basic information regarding the content provider and the services the content provider provides. The profile may further include a profile of the content for delivery. The proposal may include a bid to provide the content for delivery to consumers through mobile devices. The bid may represent a value to be exchanged with the host entity in return for permission to participate and/or use the content delivery system. For example, the value may include monetary value as well as services and/or goods to be exchanged between the content provider and the host entity. Each bid may be unique and the bid may differ based on the content provider, the content, the host entity, the delivery characteristics of the content, such as the time and location for delivery of the content.

At block 206, the proposal is evaluated by the host entity of the content delivery system. The proposal may be evaluated against a set of criteria established by the host entity. The evaluation may include a variety of factors, including, but not limited to, value to host entity, desirability of content to the host entity and/or the consumer, elements of content, and marketing segment to which the content is targeted.

At block 210, the proposal of the content provider is approved or not approved by the host entity of the content delivery system. For example, the proposal may be not approved because the content proposal is not acceptable to the host entity or the content proposed is not desired at the present time as judged by the host entity. The proposal may be approved based on past experiences with the content provider and the host entity. If the proposal is not approved, the method 200 proceeds to block 210 wherein the content provider can take no further action or can resubmit a new proposal at block 204. In some embodiments, the host entity may provide feedback to the content provider regarding the reason for not approving the proposal. The proposal approval may be an approval of the content provider to participate in the bid process to provide content. The proposal may not be a guarantee of acceptance of content from the content provider. The proposal process may be a screening process to control access to the content delivery system.

At block 212, the provisioning platform access granted to the content provider by the host entity of the content delivery system.

At block 214, a bid is placed by the content provider on content delivery to be delivered by the host entity. The bid may be submitted to the bidding platform. The bidding platform may use one or more algorithms to evaluate the bid. The algorithms may employ a variety of criteria to evaluate the bid. For example, the criteria may include, but are not limited to, bid value to the host entity and/or the consumer, consumer ratings of similar content or of the same content from the content provider or from a similar content provider, first bid of the content provider, time criteria for distribution of the content, marketing segment to which the content is to be marketed, delivery audience for the content, delivery location for the content, and delivery time parameters of the content.

At block 216, the bid of the content provider is accepted or not accepted by the host entity of the content delivery system. If the bid is not accepted, the method may return to block 214 for a submission of another bid. If the bid is accepted, the method may proceed to block 218.

At block 218, the content is uploaded and delivered to the provisioning platform by the content provider. The content may be uploaded over a computer-based network. The content may be uploaded with an attached profile. The profile may be that of the content provider as well as a profile of the content and its parameters. The profile may be that established in block 204 or it may be a different profile. For example, the profile may include a target consumer audience for the content as well as a timeframe for delivery of the content. The timeframe may specify the content is only to be pushed during a certain timeframe. The content may be delivered, following an action by the consumer with a mobile device, based on the profile established by the content provider. That is, the content may be delivered to a particular audience based on particular parameters as established in the profile. The host entity may be able to filter content and rate content to provide the most relevant content to consumers. The ratings may be based on feedback from consumers as described herein. The filtering may occur at the provisioning platform.

At block 220, feedback regarding the content is provided by the host entity to the content provider. The feedback may include metrics regarding how many times the content was pushed to mobile devices over a particular time period, what mobile device types the content was pushed to, when the content was pushed, the demographic to which the content was pushed, the location of the mobile devices to which the content was pushed, and consumer feedback regarding the content. The demographic may include information relating to the profile of the consumers and/or the mobile device to which the content was pushed. For example, the demographic may include type of mobile device, location of mobile device when the content was pushed, the sex, age, and profession of the user associated with the mobile device. Other demographic information is possible. The host entity may provide systems and methods for consumer to provide feedback regarding content pushed to them. For example, the consumer may provide feedback through an application on the mobile device or through a website.

It should be appreciated that the content provider may receive its own feedback on the content through tracking of redemption of offers and consumer feedback. In some embodiments, the content provider may provide a system and method through which consumers can provide feedback directly to the content provider. This feedback may be used to alter the content provided according to exemplary embodiments. The alteration may include submitting updated content based on this feedback and redemption. For example, if no offers included with the content are being redeemed, then the content provider may alter the offer, such as changing the delivery segment or increasing a discount in the offer, to try to make it more acceptable and then push this updated content to the host entity for delivery.

FIG. 3 is a method according to exemplary embodiments. Exemplary method 300 is provided by way of example, as there are a variety of ways to carry out the methods disclosed herein. The method 300 as shown in FIG. 3 may be executed or otherwise performed by one or a combination of various systems, such as a computer implemented system. For example, the system 100 may be used to implement the method 300. Each block shown in FIG. 3 represents one or more processes, methods, and/or subroutines carried out in the exemplary method 300. Each block may have an associated processing machine or the blocks depicted may be carried out through one processor machine.

At block 302, a consumer opts-in to the content delivery system. The consumer may register with the host entity to participate in the content delivery system. The registration may be conducted via a website over a computer-based network or through an application or program on a mobile device. As part of the registration, the consumer may provide information to develop a profile such that relevant content can be provided to the consumer. The consumer may register one or more mobile devices with the content delivery system. The registration of the mobile devices may enable content to be synchronized across each of the mobile devices.

The registration process may include providing the consumer with log-in information to the content delivery system. The consumer may be required to input log-in information into their mobile device to enable their device to use the content delivery system. The log-in process may identify the consumer with the mobile device and enable the mobile device to be used with the system according to exemplary embodiments. An application or website on the mobile device may be used. Following log-in, a set of credentials may be provisioned on the mobile device from the host entity. The provisioning may ensure that the mobile device then is properly identified in the future by the system and that the system can be used. The provisioning may be secure. The credentials may be stored in a non-transitory memory or storage device associated with the mobile device, such as, for example, a memory card. The consumer may be required to provision each mobile device. Because the credentials may be stored in non-transitory storage, the credentials may be portable between mobile devices. For example, the consumer may purchase a new mobile device and discard an old mobile device. The consumer may transfer the non-transitory memory with the credentials between the old and new mobile devices.

In some embodiments, the consumer may pay a registration fee to participate in the content delivery system. The registration fee may be optional. The registration fee may allow the consumer to receive different or premium content that is not available to consumers who do not pay the registration fee. The different or premium content may include specific content from specific content providers. For example, this content may generally include more lucrative offers.

In some embodiments, block 302 may be an optional step. In these embodiments, the consumer may not be required to register or opt-in. The consumer may receive content. In some embodiments, the consumer may be required to opt-out of the content delivery system. The opt-out process may be the reverse of the opt-in process.

At block 304, an affirmative action is taken using a mobile device. The mobile device may be communicatively coupled to a computer-based network, such as a wireless or cellular network. The affirmative action may be a tap using an NFC-capable mobile device at an NFC tag. As described above, other actions may be used in place of an NFC tap. For example, a QR code could be read by the mobile device or the consumer may manually go to a website and request content be pushed to the mobile device. In some embodiments, the affirmative action may be entering a particular location with the mobile device. Geo-fencing may be used to construct areas such that when a mobile device enters the area, the content delivery system is triggered. Locating mechanisms may be used to determine the location of the mobile device such as wireless or cellular triangulation or use of Global Positioning System (“GPS”) data.

For example, the consumer may tap their mobile device at a NFC-enabled location, e.g., by interacting with an NFC tag. The NFC tag may be tied to the cloud-based computing environment. The NFC tag may be located at any of a variety of locations. For example, the NFC tag may be located at retail locations, such as at point of sale locations or at common areas in shopping locations. The NFC tag may be located in hotspots or in posters or other media. The hotspots may include stations, pads, or kiosks that are NFC enabled for interaction with exemplary embodiments. The NFC tag may be identified as being associated with the content delivery system.

At block 306, following the affirmative action, the content delivery system is triggered. The NFC tap, according to exemplary embodiments, may cause the mobile device to generate an ID token or other data packet. The token may contain information regarding the mobile device the token originated from and the location of the NFC tap. This token or data packet may be sent as a trigger signal e.g., from the mobile device over the network, such as the wireless or cellular network, to the content delivery system. For example, the trigger signal may be sent as a HTTP request. Other protocols may be used.

In some embodiments, the trigger signal may be transmitted from the NFC enabled location. The NFC enabled location may be communicatively coupled to a network, such as a wireless or wired network or a combination thereof. The mobile device tap may trigger the formation of a token or data packet which is then transmitted from the NFC enabled location. The NFC enabled location may receive profile data and/or the credentials from the mobile device to identify the mobile device in the trigger signal. For example, the trigger signal may be sent as a HTTP request from the NFC enabled location. Other protocols may be used.

Upon receipt of the trigger signal, content may be selected and queued to be pushed to the mobile device.

At block 308, the content is pushed to the mobile device. The content is pushed to the mobile device over the network, such as the wireless or cellular network. The content may be pushed as data to the mobile device and may require the use of a data network. The content pushed to the mobile device is stored content in the content delivery system from one or more content providers who have successfully bid to have their content provided. The content may be a single piece of content or the content may be multiple pieces of content, each either from a single content provider or multiple content providers. The content may be from multiple content providers with multiple pieces of content from each content provider.

The content may be any of different types of content. For example, the content may include coupons, incentives, sales notifications, loyalty rewards, news, or other media. The content may be configured to be electronically used. For example, coupons may be e-coupons or a redemption code may be provided. Thus, the consumer may not be required to print out any items. The content may be pushed to a program or application on the mobile device that may allow for the management and storage of the content. The content may be stored for later usage.

The content pushed may be customized or tailored to the consumer based on a profile of the consumer. The profile may be associated with the consumer and may contain preferences and a history of the consumer's actions and use. The profile may be initially constructed during the registration process. In other embodiments, the profile of the consumer may be built over time based on the consumer's actions. For example, the profile may contain information regarding the consumer's past NFC taps, pushed content, mobile device use, and redemption of offers. Thus the content pushed to the consumer's mobile device may be meaningful and relevant to the particular consumer. The content pushed may be based on intelligence about the consumer based on their behavior. The content may be based on the consumer's content interest as defined by the profile and/or previous actions taken.

According to some embodiments, content may be pushed to all mobile devices in the network or an identified subset of mobile devices. This content may be pushed without any affirmative action required. This content may be applicable to everyone. For example, this content may be an offer pertinent to all users of the network.

For example, a mobile device may be tapped at an NFC tag point at the entrance to a shopping center. The content pushed to the mobile device in response may be related to various stores located at the shopping center. The content may further be tailored to the consumer based on their profile. Thus, two different consumers tapping their mobile devices at the same NFC point may receive differing content. One consumer may desire to receive only content related to clothes and shoes and the other consumer may desire to receive content related to cooking items or food. The content pushed may be based on the past behavior of the consumer. For example, one consumer may have only previously tapped their mobile device at an electronics store, so the content pushed to their mobile device may be related to electronics items. In some embodiments, there may be common content between the two different consumers because some content may be general and flagged to be pushed to a broad audience of mobile device users at a particular location. For example, some content may be news or sports related or related to a shopping center wide sale or set of offers.

In some embodiments, the use of the content delivery system may be outside of any data plan associated with the mobile device. For example, a consumer may have a data plan associated with their mobile device. The data plan may allow them to use a particular amount of data bandwidth in a set time period for a fee. The data bandwidth used by the content delivery system may fall outside of that data plan and thus may not use any of the consumer's allotted data bandwidth, either because the content is delivered through a mechanism. In other embodiments, the content delivery system use may be counted against the consumer's data bandwidth total.

In some embodiments, the content pushed may be time and location dependent. For example, the content pushed may vary based on the time of the action being conducted (i.e., the NFC tap). For example, a consumer may receive different content at 11 AM than at 5 PM in the same location. The content pushed may vary based on location. For example, a consumer may receive different content from two different locations in a shopping center or even within the same merchant location. Thus, the consumer may be incentivized to use the system at different times and locations.

At block 310, the content is reviewed, stored, and/or used by the consumer.

In some embodiments, the content may direct the consumer to an external website associated with the content provider. For example, a link may be embedded in the content to allow access to the external website. The content may auto redirect the consumer to external website once the content is accessed. In other embodiments, the consumer may be required to actuate the link to the external website. That is, the consumer may be required to take action to access the external website. The consumer may be authenticated to the external website based on the link. For example, when a consumer is redirected or accesses the external website, an implicit method (instead of an explicit sign-in with a credential) of identifying the consumer may be used. This may be done to enhance the consumer experience. There are several ways in which the identification may be performed. For example, a Unique ID Header (UIDH) may be used. The UIDH may be a hash of the mobile number associated with the mobile device. This UIDH may then identify the consumer since the mobile number is associated with them. The host entity, such as, but not limited to, a wireless carrier may insert the UIDH into the HTTP header for the external website during content delivery or when the link is actuated, such as before the payload leaves the carrier's network. Another approach may be having the mobile device send an administrative SMS or other text based message to the content provider which can be used to identify and authenticate the consumer. The message may be triggered by the content itself and may be transmitted upon actuation of the link or upon receipt of the content. The message may contain identifying information related to the consumer and may identify the content as well as the mobile device to which the content was pushed. For example, the message may contain a mobile number or serial number associated with the mobile device. It should be appreciated that other methods may be used.

At block 312, feedback is provided on the content. As part of the content delivery system, a feedback system may be used. The feedback system may allow the consumer to provide feedback regarding the content they have received. The feedback may include ratings and comments on the content. The feedback may be provided through an application or program or a website. Instructions may be provided by the host entity regarding how to provide feedback.

FIG. 4 depicts operation of a system according to exemplary embodiments. The system 400 may depict operation of the content delivery system according to exemplary embodiments are described herein. The operational depiction of the system 400 is meant to be exemplary and non-limiting.

The system 400 may include a mobile device 402. The mobile device 402 may be any type of mobile computing device or portable electronic device. For example, the mobile device 402 may be a smart phone, a tablet computing device, a laptop computing device, a netbook computing device, a cellular telephone.

The mobile device 402 may be associated with a telecommunications carrier 404. For example, the mobile device 402 may be associated with a cellular and wireless provider. The mobile device 402 may be configured for use on the provider's cellular and wireless network 406 for voice and data usage. In other words, the consumer who is associated with the mobile device 402 may have a usage plan with the provider.

The network 406 may have a set of cloud services 408 associated therewith. Associated with and communicatively coupled to both the network 406 and the cloud services 408 may be a campaign tool 410 and a data analytics module or system 412.

As described herein, content providers 414A, B, C, and D may be participants in the system 400. It should be appreciated that although four content providers are depicted in FIG. 4, there may be more or less content providers participating in the system 400. The content providers 414A, B, C, and D may be brands, retailers, marketing firms, service providers, and other such entities. For example, the content providers 414A, B, C, and D may be retailers who provider products and/or services to consumers.

Each content provider 414A, B, C, and D may be required to submit a proposal to the campaign tool 410 to participate in the system 400. Each content provider 414A, B, C, and D may be pre-screened based on this proposal. Upon acceptance of the proposal, each content provider 414A, B, C, and D may be allowed to bid to campaign tool 410 for inclusion of its content in the system 400. Once a bid is accepted, the each content provider 414A, B, C, and D may provide content 416A, B, C, and D, respectively, to the campaign tool 410. The content 416A, B, C, and D may be one or more pieces or data sets of content as described herein. The data analytics module 412 may provide support to the campaign tool 410 for the management and distribution of the content 416A, B, C, and D.

Thus, in operation, the system 400 receives a trigger signal 420 from the mobile device 402. The trigger signal 420 may be a HTTP request containing data regarding the mobile device 402 and an associated NFC tap or actuation. Thus, an affirmative action involving by the mobile device 402 may be required to use the system 400. The trigger signal 420 may be sent over the network 406 associated with the provider 404. In some embodiments, the trigger signal may be sent to the cloud services 408. The trigger signal 420 may be received by the cloud services 408 and terminate at the campaign tool 410. The campaign tool 410 and/or the data analytics module 412 may process the trigger signal 420 to determine relevant and applicable content, selected from the content 416A, B, C, and D, to push to the mobile device 402.

The campaign tool 410 may then push the content to the mobile device 402 using the data signal 422. The content may be pushed to the mobile device 402 using the cloud service 408 and/or the network 406.

The content may include one or more of the content 416A, B, C, and D. Each piece of content may be different. The content pushed from the content 416A, B, C, and D may be selected based on a profile of the user associated with the mobile device 402. The profile may be based on user selected preferences and/or historical behavior of the user using the system 400.

It should be appreciate that while a single mobile device 402 is depicted, there may be multiple mobile device associated with the user of the mobile device 402. The system 400 may push the content to each mobile device associated with the user either coincidentally with the data signal 422 or subsequent to the data signal 422.

According to exemplary embodiments, the data exchange between the mobile device 402 and the campaign tool 410 may occur entirely within the network 406 of the provider 404.

It should be appreciated that while the term “signal” is used in the preceding description, this term is meant to be non-limiting and meant to encompass various types of data packets and notifications that may be sent over the wireless or cellular network.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A computer-implemented method, comprising:
receiving, by at least one computer processor, a proposal, from an entity, to provide content to one or more mobile devices;
evaluating the proposal against a set of pre-determined criteria;
electronically providing a first determination regarding an approval of the proposal;
receiving, by the at least one computer processor, a bid to provide the content to the one or more mobile devices;
evaluating the bid using one or more algorithms;
electronically providing a second determination regarding an approval of the bid; and
receiving, by the at least one computer processor, the content for distribution to the one or more mobile devices.

2. The method of claim 1, wherein the proposal is not approved.

3. The method of claim 1, further comprising:
receiving a second proposal from the entity following the proposal not being approved.

4. The method of claim 1, wherein the one or more algorithms evaluate the bid against a set of criteria comprising one or more of: bid value, consumer ratings of similar content or previous content from the entity, a marketing segment to which the content is directed, and a time frame for delivery of the content.

5. The method of claim 1, further comprising:
receiving a profile from the entity that comprises a target audience to receive the content.

6. The method of claim 5, wherein the profile is received coincident with the bid.

7. The method of claim 5, wherein the profile further comprises a delivery window for the content.

8. The method of claim 1, comprising:
receiving, electronically, over a network, a data packet from a mobile device of the one or more mobile devices, wherein the mobile device is communicatively coupled to the network and the data packet is transmitted from the mobile device following an action involving the mobile device;
analyzing, by the at least one computer processor, the data packet wherein the data packet comprises information about an identity of the mobile device and a geographic location of the mobile device;
selecting, by the at least one computer processor, content from one or more content providers based on the analysis of the data packet; and
providing, over the network, the content to the mobile device.

9. The method of claim 8, further comprising:
receiving, by the at least one computer processor, registration information from a user of the mobile device, wherein the registration information comprises an opt-in to receive the content and a profile of the user.

10. The method of claim 9, wherein the selected content is selected based on the profile of the user.

11. The method of claim 8, wherein the action comprise an NFC tap.

12. A system, comprising:
a processor; and
a memory comprising computer-readable instructions which when executed by the processor cause the processor to perform the steps comprising:
receiving a proposal, from an entity, to provide content to one or more mobile devices;
evaluating the proposal against a set of pre-determined criteria;
providing a first determination regarding an approval of the proposal;
receiving a bid to provide the content to the one or more mobile devices;
evaluating, using one or more algorithms, the bid;
providing a second determination regarding an approval of the bid; and
receiving the content for distribution to the one or more mobile devices.

13. The system of claim 12, wherein the proposal is not approved.

14. The system of claim 12, further comprising:
receiving a second proposal from the entity following the proposal not being approved.

15. The system of claim 12, the one or more algorithms evaluate the bid against a set of criteria comprising one or more of: bid value, consumer ratings of similar content or previous content from the entity, a marketing segment to which the content is directed, and a time frame for delivery of the content.

16. The system of claim 12, further comprising:
receiving a profile from the entity that comprises a target audience to receive the content.

17. The system of claim 16, wherein the profile is received coincident with the bid.

18. The system of claim 16, wherein the profile further comprises a delivery window for the content.

19. The system of claim 12, further comprising:
receiving a data packet from a mobile device of the one or more mobile devices, wherein the mobile device is communicatively coupled to the network and the data packet is transmitted from the mobile device following an action involving the mobile device;
analyzing the data packet wherein the data packet comprises information about an identity of the mobile device and a geographic location of the mobile device;
selecting content from one or more content providers based on the analysis of the data packet; and
providing the content to the mobile device.

20. The system of claim 19, further comprising:
receiving registration information from a user of the mobile device, wherein the registration information comprises an opt-in to receive the content and a profile of the user.

21. The system of claim 20, wherein the selected content is selected based on the profile of the user.

22. The system of claim 19, wherein the action comprise an NFC tap.
